(19) United States
(12) Patent Application Publication
(10) Pub. No.: US 2024/0352852 A1
(43) Pub. Date: Oct. 24, 2024

(54) SYSTEMS AND METHODS FOR MODELING DISPLACEMENT SPECTRUMS FROM DISTRIBUTED ACOUSTIC SENSING OF STRAIN MEASUREMENTS FOR MOMENT MAGNITUDE ESTIMATION

(71) Applicant: Schlumberger Technology Corporation, Sugar Land, TX (US)

(72) Inventor: Takashi Mizuno, Houston, TX (US)

(21) Appl. No.: 18/639,443

(22) Filed: Apr. 18, 2024

Related U.S. Application Data
(60) Provisional application No. 63/496,739, filed on Apr. 18, 2023.

(51) Int. Cl. E21B 47/135; E21B 47/107; G01H 9/00

(52) U.S. Cl. CPC E21B 47/135; E21B 47/107; G01H 9/004

(57) ABSTRACT

Systems and methods may be used to process seismic data acquired using a sensor array including optical fiber sensors in a seismic acquisition environment for modeling displacement spectrums from distributed acoustic sensing (DAS) of strain measurements for moment magnitude estimation. For example, a method may include receiving DAS data of strain measurements from a plurality of sensors of an oil and gas well system, converting the DAS data to displacement data using a conversion algorithm, generating a displacement spectrum model based on the displacement data, and estimating a moment magnitude of a seismic moment using the displacement spectrum model.

### BACKGROUND

The present disclosure relates to processing seismic data acquired using a sensor array including optical fiber sensors in a seismic acquisition environment for modeling displacement spectrums from distributed acoustic sensing (DAS) of strain measurements for moment magnitude estimation.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as an admission of any kind.

Oil and gas exploration and production is a remarkably complex endeavor. A variety of surface and downhole measurement tools may be used to identify areas of a geological formation that may contain materials of interest, such as hydrocarbon reserves. A recent development of optical fiber-based seismic sensing technologies such as DAS provide industries (e.g., oil and gas industry) with new options for seismic sensing. For example, in borehole seismic, the DAS provides a viable alternative to downhole particle motion sensor (e.g., geophone, accelerometer, and so forth) arrays with high sensor count, flexible deployment, and long-term operation. Unlike geophone-based acquisition systems, optical fiber-based acquisition systems may measure physical properties (e.g., strain, temperature, and so forth) other than particle motions (e.g., velocities, accelerations, and so forth).

### SUMMARY

A summary of certain embodiments described herein is set forth below. It should be understood that these aspects are presented merely to provide the reader with a brief summary of these certain embodiments and that these aspects are not intended to limit the scope of this disclosure.

Certain embodiments of the present disclosure include a method that includes receiving distributed acoustic sensing (DAS) data of strain measurements from a plurality of sensors of an oil and gas well system. In addition, in certain embodiments, the method may include converting the DAS data to displacement data using a conversion algorithm. In addition, in certain embodiments, the method may include generating a displacement spectrum model based on the displacement data. In addition, in certain embodiments, the method may include estimating a moment magnitude of a seismic moment using the displacement spectrum model.

Various refinements of the features noted above may be undertaken in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 illustrates a schematic diagram of an oil and gas well system having a fiber-optic sensor array in a wireline deployment, in accordance with embodiments of the present disclosure;

FIG. 2 illustrates a schematic diagram of the oil and gas well system having the fiber-optic sensor array in a completion deployment, in accordance with embodiments of the present disclosure;

FIG. 3 illustrates a schematic diagram of the oil and gas well system having the fiber-optic sensor array in a permanent deployment, in accordance with embodiments of the present disclosure;

FIG. 4 illustrates a displacement spectrum and corresponding DAS spectrum, the displacement spectrum converted from the DAS spectrum, in accordance with embodiments of the present disclosure;

FIG. 5 illustrates a true displacement spectrum and displacement spectrum converted from relatively noisy DAS data, in accordance with embodiments of the present disclosure;

FIG. 6 illustrates another true displacement spectrum and displacement spectrum converted from relatively noisy DAS data, in accordance with embodiments of the present disclosure;

FIG. 7 illustrates the fitting in with the original spectrum model, in accordance with embodiments of the present disclosure;

FIG. 8 illustrates a comparison of moment magnitude as estimated by three-component (3C) geophone simulation versus one-component (1C) DAS simulation, in accordance with embodiments of the present disclosure; and

FIG. 9 is a workflow of a method of using a control system to estimate moment magnitude of a seismic moment, in accordance with embodiments of the present disclosure.

### DETAILED DESCRIPTION

One or more specific embodiments of the present disclosure will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and operation-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Certain examples commensurate in scope with the originally claimed subject matter are discussed below. These examples are not intended to limit the scope of the disclosure. Indeed, the present disclosure may encompass a variety of forms that may be similar to or different from the examples set forth below.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “certain embodiments,” “one embodiment,” or “an embodiment” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

As used herein, the terms “connect,” “connection,” “connected,” “in connection with,” and “connecting” are used to mean “in direct connection with” or “in connection with via one or more elements”; and the term “set” is used to mean “one element” or “more than one element.” Further, the terms “couple,” “coupling,” “coupled,” “coupled together,” and “coupled with” are used to mean “directly coupled together” or “coupled together via one or more elements.” As used herein, the terms “up” and “down,” “uphole” and “downhole”, “upper” and “lower,” “top” and “bottom,” and other like terms indicating relative positions to a given point or element are utilized to more clearly describe some elements. Commonly, these terms relate to a reference point as the surface from which drilling operations are initiated as being the top (e.g., uphole or upper) point and the total depth being the lowest (e.g., downhole or lower) point, whether the well (e.g., wellbore, borehole) is vertical, horizontal or slanted relative to the surface.

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequently, during operations of the systems (e.g., while the systems are operating). In addition, as used herein, the terms “continuous”, “continuously”, or “continually” are intended to describe operations that are performed without any significant interruption. For example, as used herein, control commands may be transmitted to certain equipment every five minutes, every minute, every 30 seconds, every 15 seconds, every 10 seconds, every 5 seconds, or even more often, such that operating parameters of the equipment may be adjusted without any significant interruption to the closed-loop control of the equipment. In addition, as used herein, the terms “automatic”, “automated”, “autonomous”, and so forth, are intended to describe operations that are performed are caused to be performed, for example, by a control system (i.e., solely by the control system, without human intervention).

In seismic sensing, near-surface seismic monitoring may have insufficient spatio-temporal resolutions caused by a limited seismic sensor density (e.g., limited by deployment difficulties or cost effectiveness). Recent development of optical fiber-based seismic sensing technologies such as distributed acoustic sensing (DAS) transforms fiber-optic cables into dense seismic sensor arrays, therefore providing the oil and gas industry with new options for seismic sensing. For instance, the DAS may provide higher sensor count, more flexible deployment, and long-term operation capability in comparison to particle motion sensors such as geophones and accelerometers. In certain embodiments, the DAS may include heterodyne Distributed Vibration Sensing (hDVS) that may enable new high-performance applications such as efficiently conducting borehole seismic and flow profiling applications.

The DAS may be used in various geophysical applications such as borehole seismic, surface seismic, shallow wellbore seismic, and so on. For example, DAS-based seismic acquisition systems may be used in borehole seismic to passively (e.g., without using controlled seismic sources) measure borehole seismic data for applications such as reservoir characterization and micro-seismic. The borehole seismic data may include seismic data (e.g., P-waves, S-waves, converted waves) measured using receivers (e.g., seismic sensors) in a well (e.g., a cased well or an open well). The borehole seismic data may be measured by DAS systems during or after drillings of exploration and appraisal wells. In some cases, subsurface imaging may use 3D vertical seismic profile (VSP) technology for improved imaging quality (e.g., high resolutions). The DAS systems may reduce VSP acquisition time from a few hours (e.g., using conventional seismic operations) to a few minutes. In certain embodiments, a fiber-optic sensor array may be used in geophysical applications. Fiber-optic sensors may be based on the DAS. Unlike particle motion sensors, the fiber-optic sensors may measure strains caused by seismic waves traveling along the sensor array.

Historically, magnitudes of microseismic events have been inferred by the estimation of the signal moment of ground motions measured by seismographs, including geophones, accelerometers, and seismometers. Since DAS does not measure ground motions, but strain caused by ground motions, methods developed for ground motion cannot be applied to DAS directly. Empirical relations between local magnitude and strain measurement can be used. However, the empirical relation may vary by region. Also, such a method generally only applies to local magnitude, not moment magnitude. In addition, magnitude may be estimated by measuring strain energy from DAS and estimating moment magnitude using the empirical relation with strain energy. However, such empirical relation generally requires validation using ground motion measurements. The embodiments described herein do not use empirical relations, as described in greater detail below.

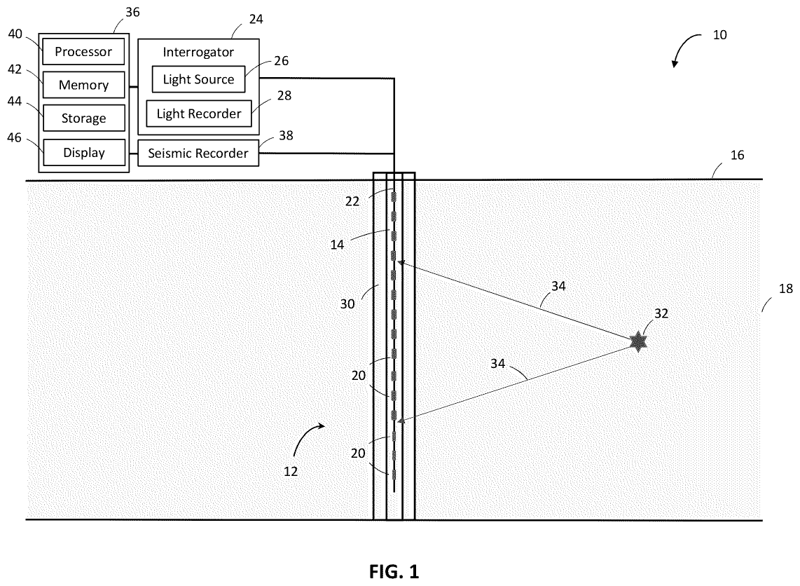

With the preceding in mind, turning now to the figures, FIG. 1 illustrates a schematic diagram of an oil and gas well system 10 having a fiber-optic sensor array in a wireline deployment. A sensor array 12 may be deployed in a borehole 14 that is drilled from a surface 16 into a subterranean formation 18. The sensor array 12 may include fiber-optic sensors 20. The fiber-optic sensors 20 may measure strains caused by seismic wavefields traveling along the sensor array 12. For example, an optical fiber cable 22 may enclose the fiber-optic sensors 20 to provide protections in a harsh borehole environment. An interrogator 24 may provide a light source (e.g., laser) 26 and a light recorder 28 configured to record light detections (e.g., detections of back scattered light signals from the fiber-optic sensors 20). In certain embodiments, the optical fiber cable 22, the interrogator 24, and the other relevant devices or components (e.g., power supplies, control circuitry, cables) may form a Rayleigh scattering based distributed acoustic sensing (DAS) system, which may use the optical fiber cable 22 to provide a distributed strain sensing. That is, the optical fiber cable 22 may become a sensing element, therefore enabling higher sensor count (e.g., densely distributed fiber-optic sensors 20), more flexible deployment (e.g., flexibility of the optical fiber cable 22), and long-term operation capability (e.g., durability of the optical fiber cable 22) in comparison to other seismic sensors such as geophones and accelerometers. The DAS system may enable acoustic frequency strain signals to be detected over large distances (e.g., a length of the well) and in relatively harsh environments (e.g., a borehole environment).

Using the DAS system may improve efficiencies of borehole seismic operations and reduce operational cost. Certain conventional borehole seismic tools may no longer be used in the borehole seismic operations. For example, operations like rigging loggers up and down along the borehole 14 may be eliminated or reduced as the fiber-optic sensors 20 are stationary in the borehole 14 while recording strains in conjunction with other stationary logging devices.

The optical fiber cable 22 may include one or more optical fibers on which the fiber-optic sensors 20 are distributed. The one or more optical fibers may be single mode or multi-mode optical fibers. In certain embodiments, the fiber-optic sensors 20 may be integrated into the one or more optical fibers using technologies such as distributed Bragg reflector (DBR) that may cause a partial reflection of an optical wave along the optical fiber cable 22. In addition, in certain embodiments, the optical fiber cable 22 may include one or more claddings to provide protections for the one or more optical fibers.

The borehole 14 may be surrounded by borehole casings 30. The borehole 14 may refer to a drilling well inside a wellbore wall or a rock face that bounds the drilling well. The borehole 14 may be a cased well or an open well. In certain embodiments, the borehole casings 30 may include pipes lowered into an open well and cemented in place. The borehole casings 30 may be configured to withstand a variety of forces, such as collapse, burst, and tensile, as well as chemically aggressive brines.

During a borehole seismic acquisition, a passive seismic event 32 (e.g., earthquake) may generate a plurality of seismic wavefields 34 that travel in various directions within the subterranean formation 18, and some of the seismic wavefields 34 may arrive at the sensor array 12, where they are measured by a corresponding sensor (e.g., one of the fiber-optic sensors 20). The passive seismic event 32 may include, but is not limited to, naturally-occurring events such as earthquakes caused by tectonics, volcanic activity, tidal forces, and so forth; induced events by human activities like oil/gas production and fluid injections; and so forth. In certain embodiments, the sensor array 12 may be connected to an optical fiber cable 22, which may be further connected to a control system 36, a seismic recorder 38, and the interrogator 24, for example, via a wireline cable or other suitable cable. In certain embodiments, the seismic recorder 38 and the interrogator 24 may be integrated into the control system 36. However, in other embodiments, the seismic recorder 38 and the interrogator 24 may be separate from the control system 36.

The control system 36 may be configured to control operations of the sensor array 12, provide certain signal sources (e.g., light source for the fiber-optic sensors 20), and receive and process data acquired by the sensor array 12. In certain embodiments, the control system 36 may include one or more processor(s) 40, memory 42, storage 44, and a display 46. The interrogator 24 may receive light signals from the fiber-optic sensors 20 and convert the light signals into fiber sensor data. The processor(s) 40 may receive the fiber sensor data from the interrogator 24. Data analysis and data processing based on the received data may be executed by the processor(s) 40 using processor-executable code stored in the memory 42 and/or the storage 44. The analyzed and processed data may be stored in the storage 44 for later usage. Analytic and processing results may be displayed via the display 46. Based on the analytic and processing results, the processor(s) 40 may adjust (e.g., automatically adjust, in certain embodiments) operations of the interrogator 24 (e.g., source light signals provided by the light source 26) or the seismic recorder 38 to adjust the borehole seismic acquisition. In certain embodiments, the processor(s) 40 may generate notification to users (e.g., well operators) based on the analytic and processing results via the communication interface.

As discussed above, the interrogator 24 may include a light source 26 that may provide source light signals (e.g., laser impulses) for the fiber-optic sensors 20. For example, in certain embodiments, the light source 26 may include wavelength tunable lasers (e.g., semiconductor lasers), such as distributed Bragg reflector (DBR) laser, vertical cavity surface-emitting laser (VCSEL), external cavity laser, distributed feedback (DFB) laser, or other suitable lasers.

As also discussed above, the interrogator 24 may also include a light recorder 28 that may receive light signals (e.g., back scattered light signals associated with local measurement of dynamic strains caused by incident seismic wavefields 34) from the fiber-optic sensors 20, convert the light signals to electrical signals (e.g., using photodetectors), and further convert (e.g., digitalize) the electrical signals into the fiber sensor data. In certain embodiments, the photodetectors may include a PIN photodiode (e.g., InGaAs PIN, GaAs PIN, or Si PIN), an avalanche photodiode (e.g., InGaAs avalanche, GaAs avalanche, or Si avalanche), or other suitable photodetector (e.g., Schottky, GaP, Ge, InAs, InAsSb, or HgCdTe photodiode).

The processor(s) 40 may be any type of computer processor or microprocessor capable of executing computer-executable code. The processor(s) 40 may include single-threaded processor(s), multi-threaded processor(s), or both. The processor(s) 40 may also include hardware-based processor(s) each including one or more cores. The processor(s) 40 may include general purpose processor(s), special purpose processor(s), or both. The processor(s) 40 may be communicatively coupled to other internal components (such as interrogator 24, seismic recorder 38, memory 42, storage 44, and display 46).

The memory 42 and the storage 44 may be any suitable articles of manufacture that can serve as media to store processor-executable code, data, or the like. These articles of manufacture may represent computer-readable media (e.g., any suitable form of memory or storage) that may store the processor-executable code used by the processor(s) 40 to perform the presently disclosed techniques. The memory 42 and the storage 44 may also be used to store data described (e.g., fiber sensor data, and so forth), various other software applications for data analysis and data processing. In certain embodiments, the memory 42 and the storage 44 may include one or more databases to store additional data such as historical data (borehole seismic data acquired in previous operations) that may be used for borehole seismic monotoring. The memory 42 and the storage 44 may represent non-transitory computer-readable media (e.g., any suitable form of memory or storage) that may store the processor-executable code used by the processor(s) 40 to perform various techniques described herein. It should be noted that non-transitory merely indicates that the media is tangible and not a signal.

The display 46 may operate to depict visualizations associated with software or executable code being processed by the processor(s) 40. In certain embodiments, the display 46 may be a touch display capable of receiving inputs from a user (e.g., a well operator or a data processor) of the control system 36. The display 46 may be any suitable type of display, such as a liquid crystal display (LCD), plasma display, or an organic light emitting diode (OLED) display, for example. Additionally, in certain embodiments, the display 46 may be provided in conjunction with a touch-sensitive mechanism (e.g., a touch screen) that may function as part of a control interface for the control system 36. It should be noted that the components described above with regard to the control system 36 are example components and the control system 36 may include additional or fewer components as shown.

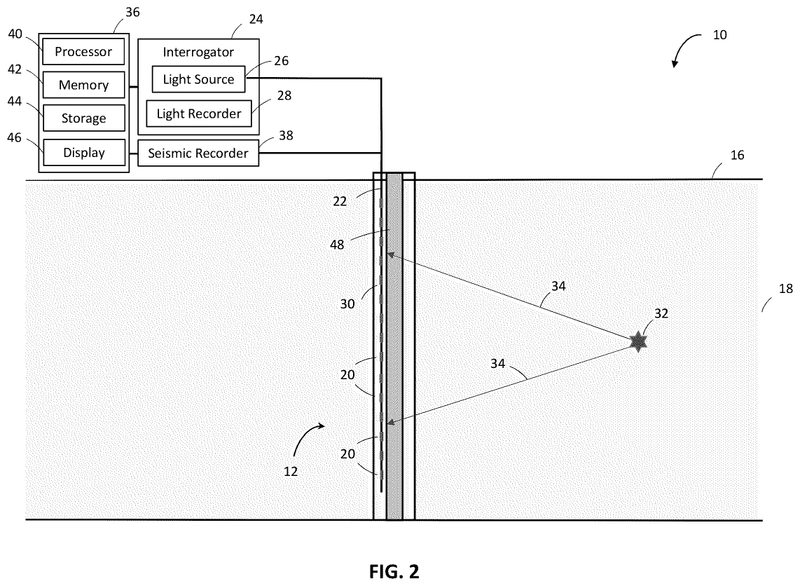

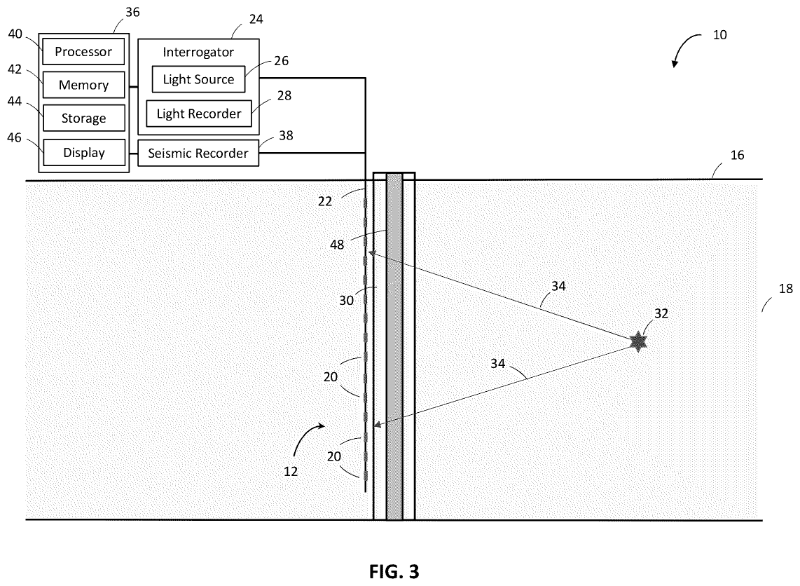

Besides a deployment illustrated in FIG. 1, in certain embodiments, the sensor array 12 may be deployed in other locations to acquire the borehole seismic data. For example, FIG. 2 illustrates a schematic diagram of the oil and gas well system 10 having the sensor array 12 in a completion deployment. The completion deployment may be used in a well completion, which is a process of configuring a well ready for a production (e.g., oil or gas) or an injection (e.g., CO₂ injection). For example, the well completion may include running in production tubing 48 and associated downhole tools as well as perforating and stimulating. In other embodiments, the sensor array 12 may be coupled to the production tubing 48. For another example, FIG. 3 illustrates a schematic diagram of the oil and gas well system 10 having the sensor array 12 in a permanent deployment. The permanent deployment may be used in a production well after the well completion. The sensor array 12 may be permanently cemented behind the borehole casings 30.

As discussed above, using the embodiments described herein, from DAS measurements, the algorithm inverts the signal moment of the displacement spectrum, and the signal moment is used to compute the moment magnitude. As described in greater detail below, in general, the embodiments of the present disclose include:
1. Converting DAS data to displacement data using a conversion equation, assuming the gauge length is 0 instead of the gauge length used in the acquisition.
2. Spectrum model fitting to displacement data inverted above. In certain embodiments, the power-law spectrum model may be assumed instead of the Omega-squared model. The algorithm inverts signal moment, corner frequency and its DAS compensation, and a DAS high-frequency decay compensation factor in the model fitting. The DAS compensations are for the gauge length effect, which is not corrected by step 1.
3. Taking the signal moment estimated at step 2, and use a conventional equation to obtain the moment magnitude.

### General Steps for Seismometers

As background for the embodiments of the present disclosure, the following equation relates to moment magnitude and signal moment of displacement data:

$${M}_{W} = \frac{2}{3} {log}_{10} [ \frac{4 πρ {V}^{3} R {Ω}_{0}}{A} ] - 6 \qquad ( 1 )$$

where M_{w} is moment magnitude, ρ is density, V is average velocity between source and receiver, R is distance, and Ω₀ is the signal moment of displacement data.

The signal moment may be estimated by the time domain integral of displacement data, which corresponds to the amplitude of the DC component of the displacement spectrum. It is relatively challenging to estimate the signal moment directly from the data by simply looking at the DC component of the data spectrum or time domain integral because of noise and low pass filters implemented in the acquisition system. As such, a model of the displacement spectrum is often fit to the data, and the signal moment is estimated instead.

Considering kinematics of an earthquake source, the omega-squared source model may often be employed as a displacement spectrum model:

$${Ω}_{R} ( f ) = \frac{{Ω}_{0}}{[ 1 + {( \frac{f}{{f}_{C}} )}^{2} ]} \qquad ( 2 )$$

where Ω_{R} is the amplitude of the displacement spectrum at each frequency f and fc is corner frequency (e.g., amplitude decay starts at fc). Ω₂, and fc may be inverted if the displacement data is available, which is often the case with seismographs are available. Then, the moment magnitude may be estimated using Ω₀, with equation (1).

### Invention for Fiber Optics Datasets

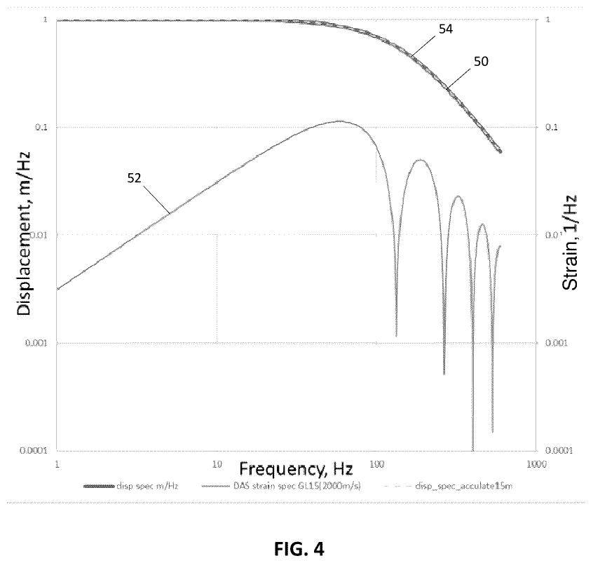

Since DAS is not displacement data, DAS data may be converted to displacement data using the relation between DAS and displacement considering the gauge length, which is a relatively important acquisition parameter of the DAS system. FIG. 4 illustrates the displacement spectrum and corresponding DAS spectrum, and the displacement spectrum converted from the DAS spectrum in case noise is not included in the data. In particular, FIG. 4 illustrates the displacement spectrum model 50, DAS response to the displacement spectrum 52, and the displacement spectrum 54 estimated from DAS data 52. For the example illustrated in FIG. 4, the gauge length is 15 meters, and the apparent velocity of the seismic data is 2,000 meters/second. In addition, Ω₀ is 1 m/Hz, and fc is 150 Hz. It is noted that the displacement spectrum converted from DAS 54 matches well with the true displacement spectrum 50, which means Ω₀ may be estimated from DAS data through the conversion of DAS to displacement including the gauge length effect, and equation (1) may be used to estimate the moment magnitude.

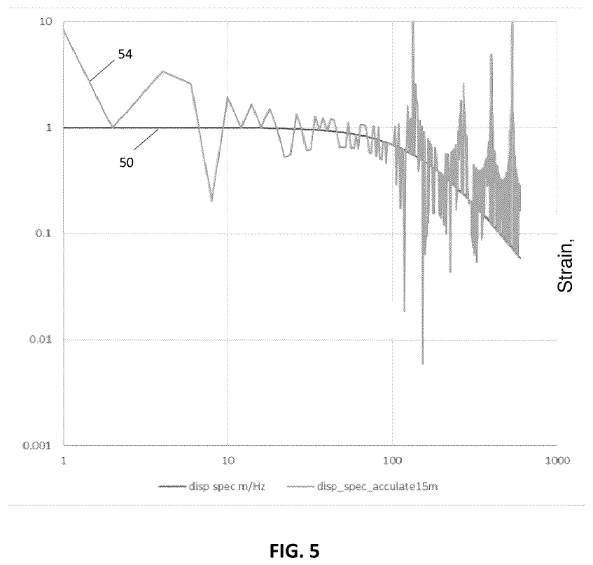

However, this approach may benefit from slight revision for noisy data. FIG. 5 illustrates the true displacement spectrum 50 and displacement spectrum 54 converted from relatively noisy DAS data 52 (e.g., where signal-to-noise ratio is 3.3). For the example illustrated in FIG. 5, the gauge length and apparent velocity of the data is the same as for the example illustrated in FIG. 4. Although the amplitude of the low-frequency side follows the true displacement spectrum 50 (Ω₀ is 1 m/Hz, and FC is 150 Hz.), the amplitude of high frequency has deviated greatly. Since amplitude is high, such high-frequency components will impact the model fitting, thereby leading to relatively low reliability to the signal moment estimate. The spikes on the high-frequency side generally occur due to the deconvolution filter for conversion of DAS to displacement. Since model fitting to this displacement spectrum is expected to be difficult, there is no reliable estimation of the signal moment Ω₀.

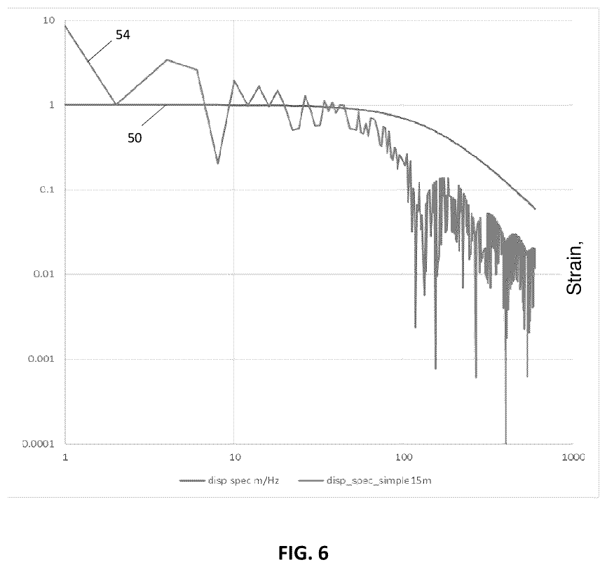

Instead of applying DAS to displacement conversion considering the gauge length used in the acquisition, the DAS may be applied to displacement conversion, assuming the gauge length is 0. FIG. 6 illustrates the true displacement spectrum 50 and displacement spectrum 54 converted from relatively noisy DAS data 52 (e.g., where signal-to-noise ratio is 3.3). For the example illustrated in FIG. 6, gauge length is assumed as 0 when the displacement spectrum is estimated. The amplitude of the spectrum on the high-frequency side is suppressed, although the low-frequency spectrum is well recovered to follow the true displacement spectrum model 50. As such, the model fitting is expected to be better than in the previous case, thereby leading to more reliable Ω₀ estimation. However, it may be possible that the signal moment could be underestimated to compensate for underestimation of the amplitude of the displacement spectrum on the high-frequency side.

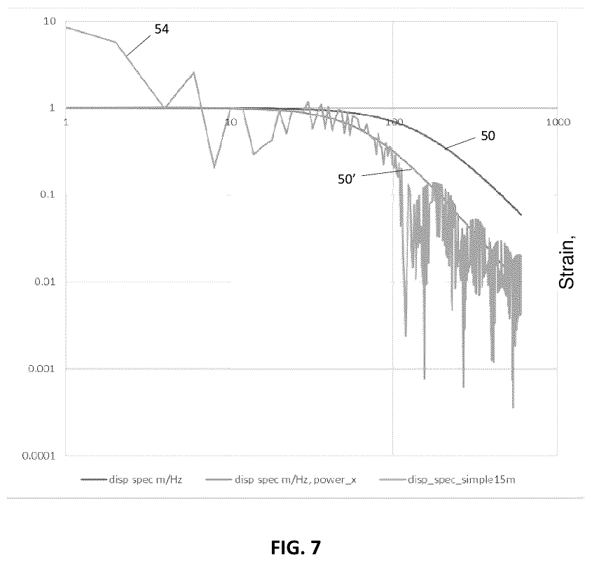

To further improve the fitting, the following modified model for the model curve fitting may be employed:

$${Ω}_{R} ( f ) = \frac{{Ω}_{0}}{[ 1 + {( \frac{f}{( {f}_{C} + {f}_{α} )} )}^{2 + α} ]} \qquad ( 3 )$$

where α and fₐ are correction factors to compensate for incomplete DAS correction (e.g., gauge length was set to 0) in the previous step. FIG. 7 illustrates the fitting in with the original spectrum model 50 (e.g., equation (1)) and the modified spectrum model 50′ (e.g., equation (3)). FIG. 7 is substantially similar to FIG. 6, but the modified spectrum model 50 described here is also presented (e.g., where signal-to-noise ratio of the DAS data 52 is 3.3, α is 0.2, and f_{α}=−80 Hz). As illustrated, the modified spectrum model 50′ is better fitting than the original spectrum model 50. In particular, the modified spectrum model 50′ explains the displacement spectrum very well from relatively low frequency to relatively high frequency. As such, Ω₀ estimation becomes more reliable for a relatively noisy case.

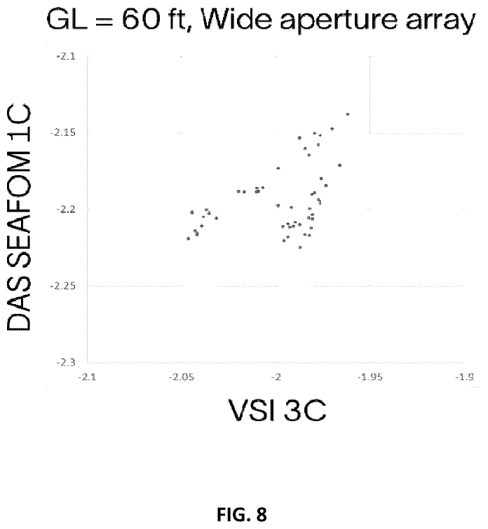

In addition, to demonstrate the developed method, synthetic data may be generated and the magnitude may be computed, as described in greater detail herein. FIG. 8 illustrates a comparison of moment magnitude as estimated by three-component (3C) geophone simulation versus one-component (1C) DAS simulation. As illustrated, while 1C DAS is estimated slightly lower than 3C geophone, because of single component measurements, the two are comparable, indicating that the embodiments described herein function as expected.

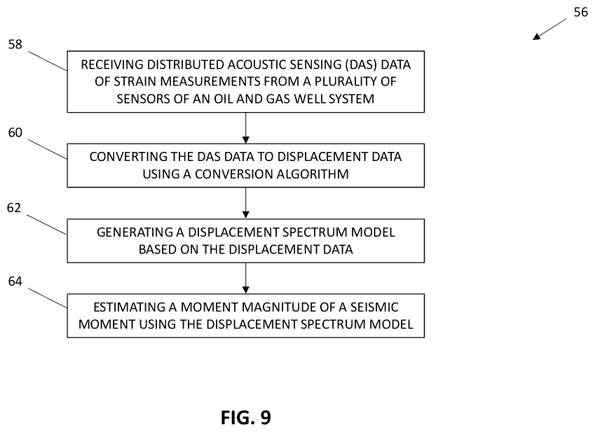

FIG. 9 is a workflow of a method 56 of using the control system 36 to estimate moment magnitude of a seismic moment, as described in greater detail herein. In certain embodiments, the method 56 may include receiving DAS data 52 of strain measurements from a plurality of fiber-optic sensors 20 of an oil and gas well system 10 (step 58). As discussed in greater detail herein, the strain measurements are measured by the fiber-optic sensors 20 based on seismic wavefields 34 that are generated by passive seismic events 32 (e.g., earthquakes) as opposed to seismic wavefields 34 that are generated by a controlled seismic source. In addition, in certain embodiments, the method 56 may include converting the DAS data 52 to displacement data 54 using a conversion algorithm (step 60). In addition, in certain embodiments, the method 56 may include generating a displacement spectrum model 50 based on the displacement data 54 (step 62). In addition, in certain embodiments, the method 56 may include estimating a moment magnitude of a seismic moment using the displacement spectrum model 50 (step 64).

In addition, in certain embodiments, the generating the displacement spectrum model 50 may include inverting a signal moment of the displacement data, a corner frequency and its DAS compensation, and a DAS high-frequency decay compensation factor. In addition, in certain embodiments, the method 56 may include estimating the signal moment of the displacement data using a time domain integral of the displacement data.

In addition, in certain embodiments, the displacement spectrum model 50 includes an omega-squared source model. In addition, in certain embodiments, the plurality of fiber-optic sensors 20 of the oil and gas well system 10 include fiber-optic sensors. In addition, in certain embodiments, the method 56 may include automatically adjusting one or more operating parameters of the oil and gas well system 10 based at least in part on the estimated moment magnitude of the seismic moment.

While the present disclosure may be susceptible to various modifications and alternative forms, specific embodiments have been shown by way of example in the drawings and have been described in detail herein. However, it should be understood that the present disclosure is not intended to be limited to the particular forms disclosed. Rather, the present disclosure is intended to cover all modifications, equivalents, and alternatives falling within the spirit and scope of the present disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
disposing a plurality of sensors within a wellbore;
receiving, by a processor, distributed acoustic sensing (DAS) data of strain measurements from the plurality of sensors;
converting, by the processor, the DAS data to displacement data using a conversion algorithm;
generating, by a processor, a displacement spectrum model based on the displacement data; and
estimating, by a processor, a moment magnitude of a seismic moment using the displacement spectrum model.

2. The method of claim 1, wherein generating the displacement spectrum model comprises:
inverting a signal moment of the displacement data, a corner frequency and the corner frequency's DAS compensation, and a DAS high-frequency decay compensation factor.

3. The method of claim 2, further comprising:
estimating the signal moment of the displacement data using a time domain integral of the displacement data.

4. The method of claim 1, wherein the displacement spectrum model comprises an omega-squared source model.

5. The method of claim 1, further comprising:
coupling the plurality of sensors to an interrogator, wherein the plurality of sensors comprise fiber-optic sensors;
providing, by the interrogator, light signals to the plurality of sensors;
detecting and recording, by the interrogator, back scattered light signals from the plurality of sensors.

6. The method of claim 5, wherein the interrogator comprises a light source and a light recorder, wherein:
the light source provides the light signals to the plurality of sensors; and
the light recorder detects and records the back scattered light signals from the plurality of sensors.

7. The method of claim 5, further comprising:
automatically adjusting one or more operating parameters of the interrogator based at least in part on the estimated moment magnitude of the seismic moment.

8. An oil and gas well control system, comprising:
a plurality of sensors; and
at least one processor configured to execute instructions stored in memory of the oil and gas well control system, wherein the instructions, when executed by the at least one processor, cause the oil and gas well control system to:
receive distributed acoustic sensing (DAS) data of strain measurements from the plurality of sensors;
convert the DAS data to displacement data using a conversion algorithm;
generate a displacement spectrum model based on the displacement data; and
estimate a moment magnitude of a seismic moment using the displacement spectrum model.

9. The oil and gas well control system of claim 8, wherein the instructions, when executed by the at least one processor, cause the oil and gas well control system to generate the displacement spectrum model by inverting a signal moment of the displacement data, a corner frequency and the corner frequency's DAS compensation, and a DAS high-frequency decay compensation factor.

10. The oil and gas well control system of claim 9, wherein the instructions, when executed by the at least one processor, cause the oil and gas well control system to estimate the signal moment of the displacement data using a time domain integral of the displacement data.

11. The oil and gas well control system of claim 8, wherein the displacement spectrum model comprises an omega-squared source model.

12. The oil and gas well control system of claim 8, wherein the plurality of sensors of the oil and gas well system comprise fiber-optic sensors.

13. The oil and gas well control system of claim 8, further comprising an interrogator coupled to the plurality of sensors.

14. The oil and gas well control system of claim 13, wherein the interrogator comprises:
a light source configured to provide light signals to the plurality of sensors; and
a light recorder configured to detect and record back scattered light signals from the plurality of sensors.

15. The oil and gas well control system of claim 8, wherein the instructions, when executed by the at least one processor, cause the oil and gas well control system to automatically adjust one or more operating parameters of the oil and gas well system based at least in part on the estimated moment magnitude of the seismic moment.
